(19) United States
(12) Patent Application Publication
(10) Pub. No.: US 2023/0185841 A1
(43) Pub. Date: Jun. 15, 2023

(54) FISHING GUIDING METHOD, SERVER, AND SYSTEM USING MACHINE LEARNING AND BIG DATA SYSTEM

(71) Applicant: SGMA CORP., Jeju-si, Jeju-do (KR)

(72) Inventors: Donghyun LIM, Jeju-si, Jeju-do (KR); Sunggil LEE, Jeju-si, Jeju-do (KR); Jinchul PARK, Busan (KR)

(73) Assignee: SGMA CORP., Jeju-si, Jeju-do (KR)

(21) Appl. No.: 17/928,863

(22) PCT Filed: Jul. 8, 2020
(86) PCT No.: PCT/KR2020/008948

§ 371 Date: Nov. 30, 2022

(30) Foreign Application Priority Data
Jun. 24, 2020 (KR) 10-2020-0076897

(51) Int. Cl. G06F 16/51; G06F 16/583; G06F 16/587

(52) U.S. Cl. CPC G06F 16/51; G06F 16/583; G06F 16/587

(57) ABSTRACT

Proposed is a fishing guiding method including the steps of: (a) determining information on a fish species recognized from an image in an online community channel by using a machine learning technique; (b) determining information on a fishing point at which and a fishing date on which the recognized species of fish was caught; (c) storing, in a big data DB, a fishing event item configured by mapping, to the information on the fish species, the determined information on the fishing point and the determined fishing date; and (d) estimating an activity of the fish species at the fishing point by using a plurality of fishing event items in the big data DB.

### TECHNICAL FIELD

The present disclosure relates to a fishing guiding method, server, and system using machine learning and a big data system and, more particularly, to a process of analyzing data related to fishing disciplines (sea, freshwater, etc.), yield (catch), yield achieving region, time, and fish species obtained from images and videos collected through various channels, such as internal and external online fishing community channels, and turning the analyzed data into big data by using machine learning and the big data system. The process is an essential procedure for establishing a system that accurately guides recommended fish species by region and recommended fishing points by fish species, which is significant as an academic value in accordance with changes in the fish species ecosystem in South Korea as the growth environment of fish species continuously fluctuates due to various environmental changes in domestic and foreign seas and freshwater (rivers, lakes, reservoirs, etc.), climate change (e.g. temperature, water temperature, wind direction, wave height, atmospheric pressure, etc.), and inflow of foreign fish species.

On the basis of the above big data, anglers may receive guidance on the area and season where their target fish species live, as well as the most suitable water temperature for fish species activity, tide time, and atmospheric pressure for each target fish species. Furthermore, by applying forecast data such as wind speed, wave height, and wind direction that determine whether fishing is possible, users may receive information on the best fishing points in the country and feeding times as well as various curation information by simply selecting the target fish species and date of fishing.

### BACKGROUND ART

These days, people enjoy a variety of leisure activities as they get to live more abundant lives. Fishing, catching fish in freshwater or in the sea, is one of the leisure activities. Fishing is a leisure activity of trying to catch fish in the water by casting a fishing line into the sea or river by the river, on the beach, or on a boat, and fishing yields quite vary by hour, date, season, and fishing point.

An angler fishing at a fishing point known for its good fishing conditions (high yields) may catch several fish, while an angler fishing at a fishing point known for its bad fishing conditions (low yields) may not be able to catch a single fish all day. Yet, even where fishing conditions are known to be poor, anglers may catch several fish during certain seasons or environmental conditions.

Various fishing points with good fishing conditions and yields are known both domestically and internationally. Anglers know the good and bad fishing conditions at a specific fishing point through experience, and may fish at the point when the fishing conditions are good. Anglers may visit and fish at specific fishing points at specific tide times according to the advice of experts. However, as the growth environment of fish species continuously fluctuates due to various environmental and climate changes in domestic and foreign seas and rivers (e.g. temperature rise, ocean current change, wind direction change, etc.) and inflow of foreign fish species, fishing point characteristics that anglers knew as a rule of thumb change from time to time and the accuracy thereof decreases.

For example, in offshore waters of Sokcho, Gangwon-do, South Korea's east coast, hairtails that live in the warm waters of the South Sea, such as off the coast of Jeju or Busan, appeared for the first time, and in offshore waters of Goseong, which is further north of Sokcho, blue marlin, a representative tropical fish, has been caught, and recently, even black bream and stone bream which are warm current fish species that have not been seen in the East Sea, have appeared.

Meanwhile, anglers exchange fishing condition/yield information with each other through various online community channels. Anglers may upload their achievements at various fishing points on these online community channels, and as their achievements become the envy of many other anglers, the corresponding fishing points may emerge as popular fishing spots.

The locations of good fishing points are constantly changing and may vary from season to season. In addition, good fishing points vary by fish species and may also change according to environmental changes.

Thus, there is a need for a fishing guiding method, server, and system using machine learning and a big data system that can recommend and guide fishing points for target fish species in consideration of above-mentioned factors.

### DISCLOSURE

### Technical Problem

The present disclosure has been made keeping in mind the problems occurring in the related art. An objective of the present disclosure is to provide a fishing guiding method, server, and system using machine learning and a big data system for analyzing fish species from images collected from online community channels using machine learning and a big data system and for creating big data that can be used for fishing guides by matching the analyzed fish species with fishing-related information.

An objective of the present disclosure is to provide a fishing guiding method, server, and system using machine learning and a big data system, which estimates a fish species activity by species associated with fishing points and times based on big data collected through online community channels and provides estimated results for fishing guides.

An objective of the present disclosure is to provide a fishing guiding method, server, and system using machine learning and a big data system, which provides a user with the optimal fishing point and additional information according to the target fish species input by the user, the date of fishing, the external environment of the date of fishing, and the activity of each fish species associated with fishing points and times.

Objectives to be achieved in the present disclosure are not limited to the objectives mentioned above, and other objectives not mentioned will be clearly understood by those skilled in the art from the description below.

### Technical Solution

In order to achieve the above mentioned objective, according to an embodiment of the present disclosure, there is provided a fishing guiding method performed by a fishing guiding server. The method includes: (a) determining information on a fish species recognized from an image in an online community channel by using a machine learning technique; (b) determining information on a fishing point at which and a fishing date on which the recognized species of fish was caught; (c) storing, in a big data DB, a fishing event item configured by mapping, to the information on the fish species, the determined information on the fishing point and the determined fishing date; and (d) estimating an activity of the fish species by using a plurality of fishing event items in the big data DB.

In the fishing guiding method, the information on the fishing point may include a fishing point identifier preset in the online community channel, and the fishing date may be a date the image was taken.

In the fishing guiding method, in the (d), a fish species activity by species associated with a fishing point and time may be estimated when the number of fishing event items stored in the big data DB exceeds a set number, or when a set cycle arrives.

In the fishing guiding method, the fish species activity may be estimated as one level among a plurality of levels according to whether the fish species is recognized at the corresponding fishing point, and the information on the fish species may include an identifier of the recognized fish species and the number of fish belonging to the recognized species.

The fishing guiding method may further include: receiving a target fish species and an expected fishing date from a user terminal; and calculating a fishing index of each of a plurality of fishing points according to weather information of the expected fishing date.

The fishing guiding method may further include: determining one or more recommended fishing points on the basis of respective fishing indices of the fishing points and a fish species activity of the target species associated with at least the plurality of fishing points, configuring recommended fishing point information and additional fishing information, and transmitting the configured information to the user terminal.

A fishing guiding server according to an embodiment of the present disclosure includes: a storage unit configured to store a big data DB containing a plurality of fishing event items, and store images obtained from online community channels; and a control unit configured to determine information on a fish species recognized from an image in the online community channels by using a machine learning technique, to determine information on a fishing point at which and a fishing date on which the recognized species of fish was caught, to store, in the big data DB, a fishing event item configured by mapping, to the information on the fish species, the determined information on the fishing point and the determined fishing date, and to estimate an activity of the fish species associated with a fishing point by using the plurality of fishing event items in the big data DB.

In the fishing guiding server, the information on the fishing point may include a fishing point identifier preset in the online community channel, and the fishing date may be a date the image was taken.

In the fishing guiding server, the control unit may estimate a fish species activity by species associated with a fishing point and time as one level among a plurality of levels according to whether a fish species is recognized when the number of fishing event items stored in the big data DB exceeds a set number, or when a set cycle arrives, and the information on the fish species may include an identifier of the recognized fish species and the number of fish belonging to the recognized species.

The fishing guiding server may further include: communication unit configured to transmit and receive data via the Internet, and wherein the control unit may receive a target fish species and an expected fishing date from a user terminal through the communication unit, calculate a fishing index of each of a plurality of fishing points according to weather information of the expected fishing date, determine one or more recommended fishing points on the basis of respective fishing indices of the fishing points and a fish species activity of the target species associated with at least the plurality of fishing points, configure recommended fishing point information and additional fishing information, and transmit the configured information to the user terminal.

A fishing guiding system according to an embodiment of the present disclosure includes: the fishing guiding server of claims 7; and

one or more user terminals.

In the fishing guiding system, each of the user terminals may access the fishing guiding server and uploads an image of a designated fishing point in an online community channel to the fishing guiding server, transmit a fishing point recommendation request including a target fish species and an expected fishing date to the fishing guiding server, and receive/output recommended fishing point information and additional fishing information determined by the fishing guiding server.

### Advantageous Effects

According to the fishing guiding method, server, and system using machine learning and a big data system of the present disclosure, it is possible to analyze fish species from images collected from online community channels using machine learning and a big data system and create big data that can be used for fishing guides by matching the analyzed fish species with fishing-related information.

Moreover, according to the fishing guiding method, server, and system using machine learning and a big data system of the present disclosure, it is possible to estimate an activity by fish species associated with fishing points and times based on big data collected through online community channels and provide estimated results for fishing guides.

Furthermore, according to the fishing guiding method, server, and system using machine learning and a big data system of the present disclosure, it is possible to provide a user with the optimal fishing point and additional information according to the target fish species input by the user, the date of fishing, the external environment of the date of fishing, and the activity of each fish species associated with fishing points and times.

The fishing guiding method, server, and system using machine learning and a big data system of the present disclosure can accurately guide recommended fish species by region and recommended fishing points by fish species even in a situation where the growth environment of fish species continuously fluctuates due to various environmental changes in domestic and foreign seas and freshwater (rivers, lakes, reservoirs, etc.), climate change (e.g. temperature, water temperature, wind direction, wave height, atmospheric pressure, etc.), and inflow of foreign fish species. This is also significant as an academic value in accordance with changes in the fish species ecosystem in Korea.

In addition, according to the fishing guiding method, server, and system using machine learning and a big data system of the present disclosure, anglers can receive guidance on the area and season where their target fish species live, as well as the most suitable water temperature for fish species activity, tide time, and atmospheric pressure for each target fish species. On top of that, by applying forecast data such as wind speed, wave height, and wind direction that determine whether fishing is possible, users can receive information on the best fishing points and feeding times in the country as well as various curation information by simply selecting the target fish species and date of fishing.

Effects obtainable in the present disclosure are not limited to the effects mentioned above, and other effects not mentioned will be clearly understood by those skilled in the art from the description below.

### DESCRIPTION OF DRAWINGS

FIG. 1 shows an exemplary fishing guiding system;

FIG. 2 is an exemplary block diagram of a fishing guiding server;

FIG. 3 is a diagram showing an exemplary control flow for estimating an fish species activity for each fishing point using a machine learning technique; and

FIG. 4 is a diagram showing an exemplary control flow for recommending a fishing point for a requested target fish species according to a user's input using estimated fish species activity for each fishing point.

### BEST MODE

The above objectives, features and advantages will become clearer through the detailed description given below in detail with reference to the accompanying drawings, and accordingly, a person of ordinary skill in the art to which the present disclosure belongs will be able to easily implement the technical idea of the present disclosure. In addition, in describing the present disclosure, if it is determined that a detailed description of known technologies related to the present disclosure may unnecessarily obscure the subject matter of the present disclosure, the detailed description will be omitted. Hereinafter, preferred embodiments according to the present disclosure will be described in detail with reference to the accompanying drawings.

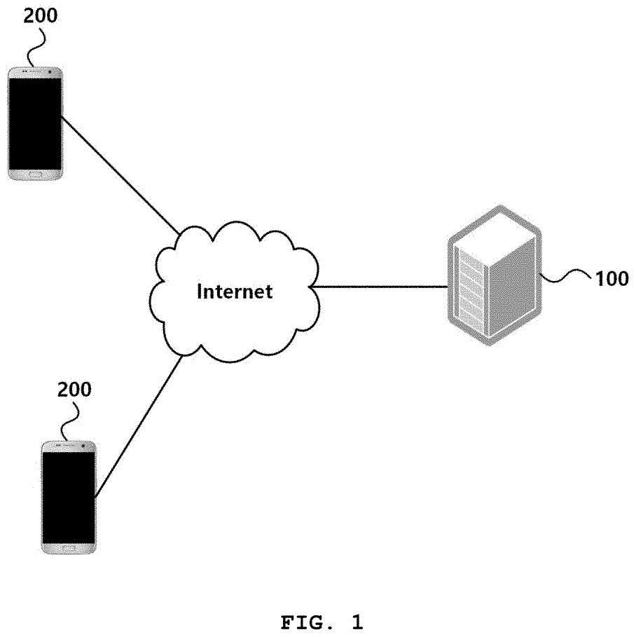

FIG. 1 shows an exemplary fishing guiding system.

A fishing guiding system for guiding anglers (users) to fishing using machine learning and a big data system includes a fishing guiding server 100 and one or more user terminals 200. The user terminal 200 and the fishing guiding server 100 may transmit and receive various data through the Internet.

The user terminal 200 is a terminal that can be used by a user who is an angler. The user terminal 200 may be, for example, a mobile phone, a smartphone, a tablet PC, and the like.

The user terminal 200 includes a processor, a non-volatile memory, a communication module, an input interface, and a display to configure an online community channel with other users through the Internet and share a variety of data or information through the online community channel.

The user terminal 200 stores an app (web) program that may be executed by the processor in a non-volatile memory and accesses the online community channel through the app (web) program to upload, download, and search images and text, etc. The online community channel may be a one-to-one conversation channel or a social networking service (SNS) through which many people can share common interests in fishing.

The online community channel used by the user terminal 200 according to the present disclosure is a shared channel through which information related to fishing may be shared, and may be, for example, a shared channel set for each fishing point (spot). The online community channel for each fishing point may be configured and provided by the fishing guiding server 100.

The user terminal 200 may access (log in) the fishing guiding server 100 and upload, download, or search a variety of data to an online community channel of one fishing point among several fishing points. The user terminal 200 may upload, for example, an image captured at a specific fishing point to the online community channel.

In addition, the user terminal 200 may request fishing point recommendation to the fishing guiding server 100 through an app program of an online community channel or another app program. The user terminal 200 may transmit a fishing point recommendation request including a target fish species (e.g., flatfish, rockfish, red snapper, etc.) and an expected fishing date to the fishing guiding server 100, receive recommended fishing point information and additional fishing information determined by and received from the fishing guiding server 100, and output the received information to a display.

Recommended fishing point information may include, for example, a fishing point identifier (name), a fishing point location, a fishing point address (location), a map, characteristics, and the like. The additional fishing information may include information related to fishing available at the recommended fishing point, such as available ship information, bait information recommended for a target fish species, and information on a nearby available services.

The fishing guiding server 100 may use a machine learning technique to extract information on fish species caught (recognized) at a specific fishing point from images (which may further include videos) shared between user terminals 200 through online community channels, create big data by using the extracted information and meteorological information that may be obtained from the date of departure for fishing (filming date), estimate or prepare to estimate the activity of fish species according to various criteria such as fishing points based on the created big data, and then provide guidance tailored to the recommendation request to the user terminal 200 according to the estimated activity level.

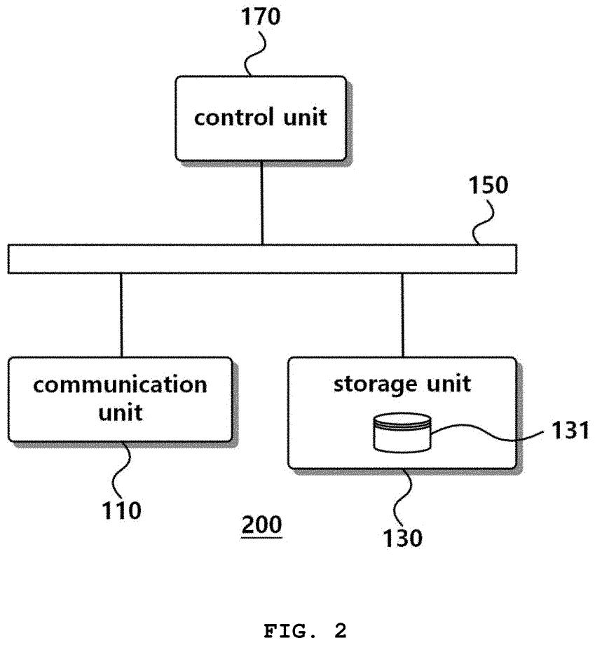

The fishing guiding server 100 will be described in detail below in FIG. 2.

FIG. 2 is an exemplary block diagram of a fishing guiding server.

Referring to FIG. 2, the fishing guiding server 100 includes a communication unit 110, a storage unit 130, a control unit 170 and a connection unit 150. The block diagram of FIG. 2 is a functional block diagram, and the fishing guiding server 100 may have various physical configurations for performing each function. For example, the fishing guiding server 100 may be divided into a plurality of physical servers or separately configured according to assigned functions. In this way, the configuration of the fishing guiding server 100 is not limited to a single server and may have various configurable server configurations. The fishing guiding server 100 may be an app server, a web server, and/or a server (device) providing an online community channel.

Looking at each functional block with reference to FIG. 2, the communication unit 110 transmits and receives data through the Internet. The communication unit 110 includes a communication chipset to be connected to a wireless LAN, a wired LAN, an optical LAN, etc., and thus may transmit and receive a variety of data.

The storage unit 130 stores a variety of data. The storage unit 130 includes a mass storage medium such as a non-volatile memory, a volatile memory, and/or a hard disk, and stores a variety of programs and data available in the fishing guiding server 100.

The programs stored in the storage unit 130 may include: a collection module that collects images from online community channels; an extraction module that extracts fish species information by applying machine learning techniques; a mapping module that maps the extracted fish species information with other information and stores it in big data; an estimation module that estimates the activity of fish species by fishing point from the collected big data; and a recommendation module that calculates fishing index and recommends fishing points upon the request of the user terminal 200. Each of the program modules may consist of a single program or a program combined with other program modules.

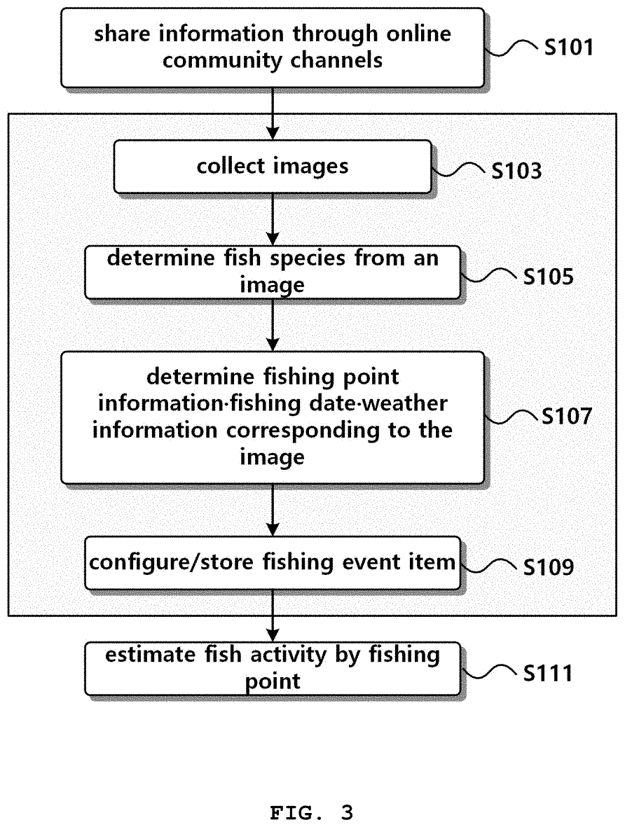

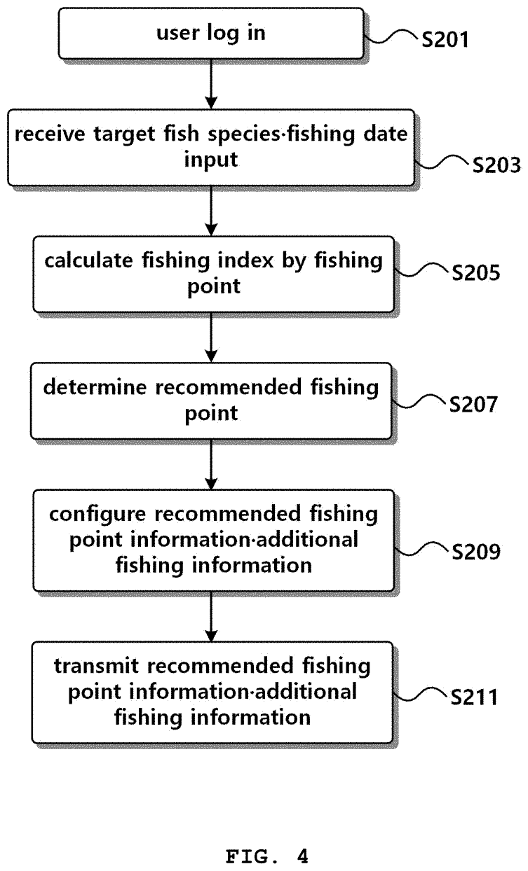

The storage unit 130 for storing a variety of data stores images obtained from online community channels configured between a big data DB 131 and the user terminal 200. The big data DB 131 includes a plurality of fishing event items, and the fishing event items are constructed from images from online community channels through machine learning. The configuration of the big data DB 131 and the process of guiding fishing using the big data DB 131 will be described in detail in FIGS. 3 and 4. The storage unit 130 may further include other user information. The user information includes at least data for identifying a user capable of accessing (login) the fishing guiding server 100, and includes, for example, a user ID and password.

The connection unit 150 transmits and receives a variety of data between blocks in the fishing guiding server 100. The connection unit 150 may transmit and receive a variety of data including one or more of a parallel bus, a serial bus, Ethernet, Wi-Fi, and the like.

The control unit 170 controls the fishing guiding server 100. The control unit 170 may control the fishing guiding server 100 through the program module of the storage unit 130. The control unit 170 may include one or more CPUs, MPUs, central processing units, microcomputers, and the like to execute program instruction codes.

Briefly looking at some control flows performed in the control unit 170, the control unit 170 determines fish species recognition and fish species information using a machine learning technique in images of online community channels. In addition, the control unit 170 determines the information on the fishing point where the recognized species was caught and the date of occurrence (fishing date) from an image, and maps the determined fishing point information, the fishing date, and the weather information of the fishing date to fish species information to configure a fishing event item.

The control unit 170 stores the configured fishing event item in the big data DB 131 of the storage unit 130, estimates fish species activity associated with each fishing point, etc. using fishing event items stored in the big data DB 131, and stores the estimated fish species activity in the storage unit 130. Thereafter, when recommending a fishing point upon user request, fish species activity information associated with each fishing point, etc. may be used.

The control flow for estimating the activity of fish species and the control flow for recommending fishing points will be examined in more detail with reference to FIGS. 3 and 4.

FIG. 3 is a diagram showing an exemplary control flow for estimating fish species activity for each fishing point using a machine learning technique.

The control flow of FIG. 3 is mainly performed by the control unit 170 of the fishing guiding server 100.

First, users share fishing-related information with each other through online community channels (S101). For example, the user terminal 200 may log in to the fishing information server 100, access an online community channel dedicated to each fishing point provided by the fishing guiding server 100, and upload a fishing picture at the corresponding fishing point to the online community channel. Alternatively, the user terminal 200 may upload fishing photos to social networking services other than the fishing guiding server 100. Preferably, the user terminal 200 may upload a fishing picture to the online community channel for each fishing point provided by the fishing guiding server 100.

The fishing point may indicate a spot or area where freshwater fishing or sea fishing is possible. For example, a fishing point may be specified as a place name, such as an island location, an archipelago location, a beach location where fishing is possible, or a spot location.

The fishing guiding server 100 may provide users with online community channels of known or expected to be known fishing points at home and abroad.

Thereafter, the fishing guiding server 100 collects images uploaded to the online community channels periodically (e.g., once a day, a week, or once a month, etc.) (S103). For example, the control unit 170 may execute the collection module to collect fishing-related photos from social networking services on the Internet and temporarily store the collected images in the storage unit 130. Alternatively, the control unit 170 may temporarily store the uploaded images in the online community channels provided by the fishing guiding server 100 for individual fishing points in the storage unit 130 by matching the identifier of the fishing point.

The fishing guiding server 100 recognizes fish species from the collected images in the online community channels and determines the fish species information representing the recognized fish species (S105). For example, the control unit 170 executes the extraction module for extracting fish species information by applying a machine learning technique, recognizes a fish species for each collected image stored in the storage unit 130, and provides fish species information indicating the recognized fish species. Fish species represent the types of live fish that can be caught by fishing, such as flounder, flatfish, yellowtail, mullet, rockfish, black sea bream, and red sea bream.

The control unit 170 executing the extraction module of the machine learning technique learned from the existing fishing images may recognize the fish species from the collected images and determine the number of fish (yield) of the recognized fish species. The control unit 170 may configure fish species information including a fish species identifier and the number of fish to specify the recognized fish species. The fish species identifier may be, for example, a name of fish species or a combination of numbers and letters assigned by the fishing guiding server 100. The fishing guiding server 100 may learn the fish species (the name thereof) from the fish species identifier.

The fishing guiding server 100 determines the information on the fishing point where the recognized species was caught, the date of fishing for the fish species recognized in an image, and the weather information of the fishing date along with the determination of the fish species information (S107). The control unit 170 may execute the mapping module to configure various types of information corresponding to the image in which the fish species is recognized in various ways.

For example, the control unit 170 may specify a fishing point identifier corresponding to the location information (GPS information) tagged in the image, determine a fishing genre corresponding to (classified according to) the fishing point identifier or the recognized fish species, and configure fishing point information including a fishing point identifier and a fishing genre. The fishing point identifier may be a name (place name) of a fishing point or a combination of numbers and letters assigned by the fishing guiding server 100. The fishing genre represents type of water you fish in and may represent, for example, freshwater fishing or sea (saltwater) fishing.

Alternatively, the control unit 170 may configure fishing point information including: a fishing point identifier preset in the online community channel provided by the fishing guiding server 100, matched with images, and stored in the storage unit 130; and a fishing genre (freshwater/sea) corresponding to the fishing point identifier or recognized fish species.

The control unit 170 may set the photographing date of the image as the fishing date, and may receive weather information of the fishing date from an external weather server through the Internet. The weather information may be weather information of a fishing date determined at a fishing point and may be information collected in advance or collected ex post facto and then matched. The weather information includes key variables related to fish, such as water temperature, wave height, atmospheric pressure, and tides (tidal information is also defined as being included in weather information), and may further include temperature, wind speed, wind direction, and precipitation.

The fishing guiding server 100 configures fishing event items by mapping fishing point information, fishing date, and weather information to the information on fish species recognized in the image, and stores the configured fishing event items in the big data DB 131 of the storage unit 130 (S109).

Through the execution of the mapping module, the control unit 170 may configure a fishing event item by mapping the determined fishing point information, the fishing date, and weather information of the fishing date to the recognized fish species information, and store the configured fishing event items in the storage unit 130. The control unit 170 may configure a fishing event item for each of all collected images and store the configured items in the big data DB 131.

The fishing guiding server 100 may create big data by repeatedly generating fishing event items from fishing images periodically according to periodic image collection (see S103 to S109).

As big data is created in the big data DB 131, the fishing guiding server 100 estimates the fish species activity associated with the fishing point (also referred to as “fish species activity by fishing point” by reflecting the main aspect) using the fishing event items stored in the big data DB 131 (S111).

The control unit 170 is configured to estimate activity by fish species using a plurality of fishing event items of the big data DB 131 through the execution of the estimation module. The activity of each fish species may be estimated according to various criteria such as fishing point and timing.

The control unit 170 may estimate fish species activity when the number of fishing event items in the big data DB 131 of the storage unit 130 exceeds the internally set number, when the internally set period for estimating the activity of fish species arrives, or when there is a user request. As the big data is sufficiently secured, the control unit 170 may estimate fish species activity by fish species (flatfish, flatfish, yellowtail, mullet, rockfish, black sea bream, red sea bream, etc.) by fishing point and time. In addition, since weather information variables such as water temperature, wave height, atmospheric pressure, and tide time are matched with big data along with fishing points, times, and species, the control unit 170 may estimate the fish species activity when a condition for combining any of the above variables is given. The activity of the fish species may represent the presence or absence, or the degree of activity (abundance) of the corresponding fish stocks.

As such, the control unit 170 may estimate the fish species activity of each fish species associated with the fishing point, time, weather information, etc. based on big data and store the estimated fish species activity information in the storage unit 130, or may prepare to immediately estimate the fish species activity.

Through the control flow shown in FIG. 3, the fishing guiding server 100 may estimate and update at least the fish species activity for each fishing point through fishing photos, etc. that may be secured from online community channels.

FIG. 4 is a diagram showing an exemplary control flow for recommending a fishing point for a requested target fish species according to a user's input using estimated fish species activity for each fishing point.

The control flow shown in FIG. 4 is performed by the fishing guiding server 100 and is preferably performed by the control unit 170 of the fishing guiding server 100 executing the recommendation module. The control flow shown in FIG. 4 is preferably performed after the fish species activity is estimated or may be immediately estimated according to the control flow of FIG. 3.

First, a user logs in to the fishing guiding server 100 using the user terminal 200 (S201). The user inputs a user ID and password to the input interface of the user terminal 200, and the control unit 170 of the fishing guiding server 100 may receive this and authenticate the user by comparing the user ID and password stored in the storage unit 130 or the like. The user may log in to the fishing guiding server 100 through a web program or an app program, request a fishing point recommendation, and receive a response.

The fishing guiding server 100 receives a fishing point recommendation request including a fish to be caught and an expected fishing date, which is a fishing date, from the user terminal 200 through the Internet (S203). The control unit 170 may receive a fishing point recommendation request including input data for specifying the target fish species (e.g., target fish species identifier (name)) and input data for specifying the expected fishing date (e.g., date of year, month, day) through the communication unit 110.

The fishing guiding server 100 calculates a fishing index of each of the fishing points based on the weather information of the expected fishing date of the fishing point recommendation request (S205). The fishing guiding server 100 may calculate the fishing index of each of the fishing points that may be guided in real time according to the reception of the expected fishing date, or calculate the fishing index of all expected fishing dates and search the fishing index of the expected fishing date.

The control unit 170 may receive weather information of an expected departure date in advance or in real time from the weather server through the communication unit 110. The weather information may be the same or different for each fishing point and may include temperature, wind speed, wave height, and precipitation.

The control unit 170 calculates the fishing index for each fishing point using the weather information for the expected fishing date corresponding to each fishing point. The control unit 170 may calculate the fishing index using different meteorological environmental factors depending on the type of fishing point (fishing genre, e.g., sea/freshwater). For example, for a fishing point located in the sea (beach), the control unit 170 calculates a fishing index by assigning internally set weights to wave height, wind speed, and precipitation, while for a fishing point located on a river (riverside), the control unit 170 calculates a fishing index by assigning internally set weights to wind speed and precipitation.

The control unit 170 may calculate the fishing index at one of the levels set (e.g., 0 (worst), 1 (poor), 2 (average), 3 (good), 4 (best)) using the environmental factors of each weather information corresponding to each fishing point.

The control unit 170 may calculate the fishing index by further using different meteorological factors according to the location of the fishing point or the external environment. For example, the control unit 170 may further use the tidal current for fishing points in the West Sea and may further use the wind direction in the case of sea fishing. When a headwind blows from the sea (for example, when an easterly wind blows at a specific fishing point on the east coast), the control unit 170 may calculate a relatively low fishing index.

Then, the fishing guiding server 100 determines one or more recommended fishing points on the basis of the fishing indexes of the expected date of individual fishing points that may provide guidance and the activity of the fish species associated with the fishing points of the target fish species (S207). The fishing index and fish species activity may be combined in various ways to determine recommended fishing points. That is, a method of calculating by assigning a weight to both or a method of recommending using the fish species activity after the fishing index satisfies the minimum requirement may be used.

On the basis of the activity of each fish species associated with the fishing points stored in the storage unit 130 or estimated immediately, the control unit 170 searches for fishing points having a high level of fish species activity at a time corresponding to the received target fish species and the received expected fishing date, and determines one or more fishing points among the searched fishing points as one or more recommended fishing points. The expected fishing date and the weather forecast information on the expected fishing date may be used to determine the activity of fish species by point. In the big data DB 131, weather information variables such as water temperature, wave height, atmospheric pressure, and tides are matched with big data along with fishing points, times, and fish species, so that the expected fishing date and the weather forecast information (water temperature, wave height, atmospheric pressure, and tides, etc.) on the expected fishing date may be used to estimate the activity of fish species by fishing point.

The fishing guiding server 100 configures one or more recommended fishing point information and additional fishing information (S209).

For example, the fishing guiding server 100 may configure recommended fishing point information including location, map, name, characteristics, etc. of the recommended fishing point, as well as additional fishing information including available ship information, bait information and feeding time recommended for fishing of the target species, information of nearby available services, etc. Various types of information related to fishing points may be stored in advance in the storage unit 130.

The fishing guiding server 100 transmits the configured recommended fishing point information and additional fishing information to the user terminal 200 in response to the fishing point recommendation request (S211). The control unit 170 transmits recommended fishing point information and additional fishing information to the user terminal 200 through the communication unit 110, and the user terminal 200 may receive the recommended fishing point information and additional fishing information through a communication module and output the received recommended fishing point information and additional fishing information by means of a display.

Through the control flow shown in FIG. 4, it is possible to recommend fishing points for the fish species desired by the user by reflecting information on fish species activity and expected weather conditions for each fishing point that is continuously updated based on big data collected through online community channels.

The present disclosure described above may be variously substituted, modified, and changed by those skilled in the art without departing from the technical spirit of the present disclosure. Thus, the present disclosure is not limited by the foregoing embodiments and accompanying drawings.

1. A fishing guiding method performed by a fishing guiding server, the method comprising:
(a) determining information on a fish species recognized from an image in an online community channel by using a machine learning technique;
(b) determining information on a fishing point at which and a fishing date on which the recognized species of fish was caught;
(c) storing, in a big data DB, a fishing event item configured by mapping, to the information on the fish species, the determined information on the fishing point and the determined fishing date; and
(d) estimating an activity of the fish species by using a plurality of fishing event items in the big data DB.

2. The fishing guiding method of claim 1, wherein the information on the fishing point includes a fishing point identifier preset in the online community channel, and the fishing date is a date the image was taken.

3. The fishing guiding method of claim 1, wherein in the (d), a fish species activity by species associated with a fishing point and time is estimated when the number of fishing event items stored in the big data DB exceeds a set number, or when a set cycle arrives.

4. The fishing guiding method of claim 3, wherein the fish species activity is estimated as one level among a plurality of levels according to whether the fish species is recognized at the corresponding fishing point, and the information on the fish species includes an identifier of the recognized fish species and the number of fish belonging to the recognized species.

5. The fishing guiding method of claim 1, further comprising:
receiving a target fish species and an expected fishing date from a user terminal; and
calculating a fishing index of each of a plurality of fishing points according to weather information of the expected fishing date.

6. The fishing guiding method of claim 5, further comprising:
determining one or more recommended fishing points on the basis of respective fishing indices of the fishing points and a fish species activity of the target species associated with at least the plurality of fishing points, configuring recommended fishing point information and additional fishing information, and transmitting the configured information to the user terminal.

7. A fishing guiding server, comprising:
a storage unit configured to store a big data DB containing a plurality of fishing event items, and store images obtained from online community channels; and
a control unit configured to determine information on a fish species recognized from an image in the online community channels by using a machine learning technique, to determine information on a fishing point at which and a fishing date on which the recognized species of fish was caught, to store, in the big data DB, a fishing event item configured by mapping, to the information on the fish species, the determined information on the fishing point and the determined fishing date, and to estimate an activity of the fish species associated with a fishing point by using the plurality of fishing event items in the big data DB.

8. The fishing guiding server of claim 7, wherein the information on the fishing point includes a fishing point identifier preset in the online community channel, and the fishing date is a date the image was taken.

9. The fishing guiding server of claim 7, wherein the control unit estimates a fish species activity by species associated with a fishing point and time as one level among a plurality of levels according to whether a fish species is recognized when the number of fishing event items stored in the big data DB exceeds a set number, or when a set cycle arrives, and the information on the fish species includes an identifier of the recognized fish species and the number of fish belonging to the recognized species.

10. The fishing guiding server of claim 7, further comprising:
a communication unit configured to transmit and receive data via the Internet, and
wherein the control unit receives a target fish species and an expected fishing date from a user terminal through the communication unit, calculates a fishing index of each of a plurality of fishing points according to weather information of the expected fishing date, determines one or more recommended fishing points on the basis of respective fishing indices of the fishing points and a fish species activity of the target species associated with at least the plurality of fishing points, configures recommended fishing point information and additional fishing information, and transmits the configured information to the user terminal.

11. A fishing guiding system, comprising:
the fishing guiding server of claim 7; and
one or more user terminals.

12. The fishing guiding system of claim 11, wherein each of the user terminals accesses the fishing guiding server and uploads an image of a designated fishing point in an online community channel to the fishing guiding server, transmits a fishing point recommendation request including a target fish species and an expected fishing date to the fishing guiding server, and receives/outputs recommended fishing point information and additional fishing information determined by the fishing guiding server.
